(19) United States
(12) Patent Application Publication
(10) Pub. No.: US 2023/0052596 A1
(43) Pub. Date: Feb. 16, 2023

(54) Triple Vice Machining Fixture

(71) Applicant: Majd Alghazzi, Houston, TX (US)

(72) Inventor: Majd Alghazzi, Houston, TX (US)

(21) Appl. No.: 17/698,327

(22) Filed: Mar. 18, 2022

Related U.S. Application Data
(60) Provisional application No. 63/231,446, filed on Aug. 10, 2021.

(51) Int. Cl. B25B 1/20

(52) U.S. Cl. CPC B25B 1/20

(57) ABSTRACT

The present invention relates to a triple vice machining fixture configured to hold up to three workpieces simultaneously. The fixture includes a circular device and features three sets of dual jaws facing-off to each other and positioned at 120 degrees relative to each other. Each jaw set includes a stationary jaw and a receptacle jaw wherein the receptacle jaw has tapered wedges that secure the workpiece in place between the stationary jaw and the receptacle jaw. The fixture has three locators proximal to the center of the vice, wherein each locator is a travel stop to the back side of the jaws and are positioned in the same circular pattern as the jaws. The vice enables machinists, hobbyists and others to maintain versatility and work on multiple items or projects simultaneously.

### CROSS-REFERENCE TO RELATED APPLICATION

The present application claims priority to, and the benefit of, U.S. Provisional Application No. 63/231,446, which was filed on Aug. 10, 2021 and is incorporated herein by reference in its entirety.

### FIELD OF THE INVENTION

The present invention relates generally to the field of vice machining fixtures. More specifically, the invention relates to an improved vice machining fixture that can hold up to three workpieces simultaneously. More specifically, the fixture includes three sets of dual jaws comprising a stationary jaw and a receptacle or movable jaw with tapered wedges. A workpiece is placed or gripped between the stationary jaw and the receptacle or movable jaw. Accordingly, the present disclosure makes specific reference thereto. Nonetheless, it is to be appreciated that aspects of the present invention are also equally applicable to other like applications, devices, and methods of manufacture.

### BACKGROUND

By way of background, a vice machine is a mechanical device designed to hold workpieces still during machining operations. Machining vices are equipped to dampen vibrations and provide excellent stability of the workpiece while performing an operation. More specifically, a conventional vice machine consists of two parallel jaws for holding a workpiece where one of the jaws is fixed and another one of the jaws is movable by a screw, lever or cam.

Conventional vices are configured to only hold a single workpiece, thereby allowing an operator to work on the single workpiece at a time. This considerably increases machining time with the operator only being able to work on a single workpiece. Further, operators may lose time in finding other workpieces that may be lost while conducting the machining process. Also, more energy and effort are required by machine operators, as operators need to clean and prep the machine more frequently between machining operation cycles.

While working with one workpiece, an operator needs to operate the jaws frequently for each workpiece. Precise holding of workpieces of various dimensions consumes more time of the operator. Operators desire a vice machine that can reduce their effort and time and hold more than one workpiece for a machining process.

Therefore, there exists a long felt need in the art for a multifunctional vice machine that can be used for holding more than one workpiece simultaneously for a machining process. There is also a long felt need in the art for a vice machine that reduces the time required to clamp, secure, and machine workpieces. Additionally, there is a long felt need in the art for a vice machine that reduces effort and energy required by machine operators to operate the jaws for installing and removing workpieces. Moreover, there is a long felt need in the art for a vice machine that reduces time to clean and prep the machine between machining cycles. Further, there is a long felt need in the art for a vice machine that enables vice machine operators to maintain versatility and work efficiency on multiple items or projects at once. Finally, there is a long felt need in the art for a vice machining fixture that saves extensive time and effort of an operator when working with the vice.

The subject matter disclosed and claimed herein, in one embodiment thereof, comprises a triple vice machining fixture. The vice machining fixture is designed to secure up to three separate workpieces simultaneously. The vice machining fixture features three sets of dual jaws positioned on a top surface of a base of the fixture. The dual jaw sets form a 120 degree angle between the center lines of each of the three sets. Each jaw set of dual jaws includes a stationary jaw and a receptacle or movable jaw, wherein a workpiece is positioned between the stationary jaw and the receptacle jaw. Each receptacle jaw has tapered metal wedges configured to be tightened by a setscrew for securing the workpiece in the dual jaws set. The fixture also has three stationary protrusion or locators positioned at the center of the fixture and aligned with the center lines of the jaw sets wherein each stationary protrusion or locator functions as a blockade, or locator stop, for a workpiece positioned in corresponding dual jaws set.

In this manner, the triple vice machining fixture of the present invention accomplishes all of the forgoing objectives and provides operators with a convenient and easy to use vice machining tool capable of holding three workpieces simultaneously. The tool reduces the time required to clamp, secure, and machine workpieces without sacrificing quality, and saves extensive time and effort when working with a vice.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multifunctional vice machining fixture. The vice machining fixture is designed to secure up to three separate workpieces simultaneously for reducing time required to clamp, secure and machine workpieces without sacrificing quality. The vice machining fixture further comprising a base includes a bottom surface and a top surface, three sets of dual jaws positioned on the top surface and equally divided by 120 degrees between the center lines of each of the three sets, each jaw set of dual jaws includes a stationary jaw and a receptacle jaw, wherein a workpiece is positioned between the stationary jaw and the receptacle jaw, the receptacle jaw includes a pair of tapered metal wedges configured to be tightened by a setscrew for securing the workpiece, three stationary protrusion or locators positioned at the center of the fixture and aligned with the center lines of the jaw sets wherein each stationary protrusion or locator functions as a blockade for the workpiece positioned in corresponding dual jaws set.

In yet another embodiment, a triple vice machining fixture is disclosed. The triple vice machining fixture includes three sets of dual jaws, each jaw set includes a stationary jaw and a receptacle or movable jaw, the receptacle jaw has tapered slanted wedges for helping in securing a workpiece between the stationary jaw and the receptacle jaw. Three protrusions are disposed at the center of the fixture wherein the protrusions are aligned with the jaw sets and thus function as a blockade, or locator stop, for the workpiece placed in each jaw set.

In yet another embodiment, a vice machining fixture for holding three workpieces simultaneously is disclosed. The fixture includes precise through holes for mounting the vice, three sets of dual jaw sets, each jaw set includes a stationary jaw and a receptacle jaw, the receptacle jaw includes tapered metal wedges for securing a workpiece between the stationary jaw and the receptacle jaw wherein the tapered metal wedges are tightened using a setscrew from a top face of a through hole disposed in the wedge. The sets of dual jaws are laid out in a circular pattern concentric with the center of the fixture body and are equally divided, forming 120 degrees between center lines of the dual jaw sets.

In yet another embodiment, the fixture holds three separate workpieces wherein each dual jaw set holds a separate workpiece.

In yet another embodiment, the fixture is made from lightweight and durable aluminum.

In yet another embodiment, the vice fixture is mounted to a surface using precise through holes and a central hole.

In yet another embodiment, the fixture has three central protrusions configured to function as a blockade, or workpiece locator stop, for the workpieces placed or gripped in the dual jaw sets.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a triple vice machining fixture of the present invention in accordance with the disclosed architecture;

FIG. 2 illustrates a perspective view showing three separate workpieces fixed in three jaw sets of the triple vice machining fixture of the present invention in accordance with the disclosed architecture;

FIG. 3 illustrates the perspective view of the vice machining fixture of FIG. 1 showing numeral references to the triangular wedges in accordance with the disclosed architecture;

FIG. 4A illustrates a side view of a tapered metal wedge used in the vice machining fixture of the present invention in accordance with the disclosed architecture;

FIG. 4B illustrates a top view of the tapered metal wedge used in the vice machining fixture of the present invention in accordance with the disclosed architecture;

FIG. 4C illustrates a side sectional view of the tapered metal wedge showing the stationary and hollow portion of the tapered wedge in accordance with the disclosed architecture;

FIG. 5 illustrates a sectional view along line A-A of the triple vice machining fixture of the present invention in accordance with the disclosed architecture;

FIG. 6 illustrates a top perspective view showing dimensions of various components of the triple vice machining fixture of the present invention in accordance with the disclosed architecture; and

FIG. 7 illustrates a perspective view of one embodiment of a fixture screw in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a multifunctional vice machine that can be used for holding more than one workpiece simultaneously for a machining process. There is also a long felt need in the art for a vice machine that reduces the time required to clamp, secure, and machine workpieces. Additionally, there is a long felt need in the art for a vice machine that reduces effort and energy required by machine operators to operate the jaws for installing and removing workpieces. Moreover, there is a long felt need in the art for a vice machine that reduces time to clean and prep the machine between machining cycles. Further, there is a long felt need in the art for a vice machine that enables vice machine operators to maintain versatility and work efficiency on multiple items or projects at once. Finally, there is a long felt need in the art for a vice machining fixture that saves extensive time and effort of an operator when working with the vice.

The present invention, in one exemplary embodiment, is a novel vice machining fixture for holding three workpieces simultaneously. The fixture includes precise through holes for mounting the vice, three sets of dual jaw sets, each jaw set includes a stationary jaw and a receptacle or movable jaw, the receptacle jaw includes tapered metal wedges for securing a workpiece between the stationary jaw and the receptacle jaw wherein the tapered metal wedges are tightened using a setscrew from a top face of a through hole disposed in the wedge. The sets of dual jaws are laid out in a circular pattern concentric with the center of the fixture body and are equally divided or separated forming 120 degrees between center lines of the dual jaw sets.

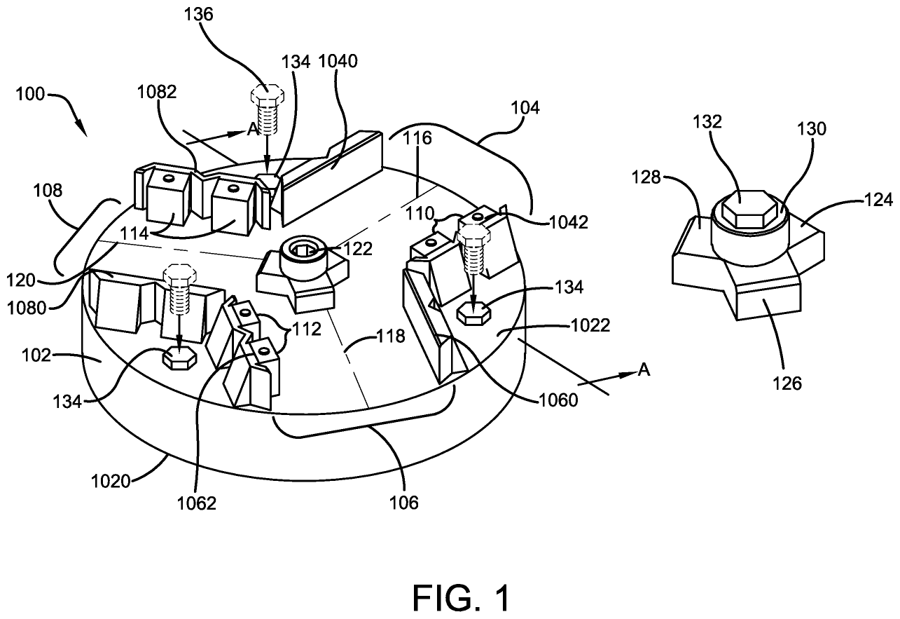

Referring initially to the drawings, FIG. 1 illustrates a perspective view of one potential embodiment of the triple vice machining fixture 100 of the present invention in accordance with the disclosed architecture. The triple vice machining fixture 100 is designed as an improved vice for securing up to three separate workpieces simultaneously. More specifically, the vice machine 100 includes a circular aluminum base 102 that is placed on a plane surface such as of a table when the machine 100 is affixed thereto. The aluminum base 102 includes a bottom surface 1020 that rests on the table and includes a top surface 1022 upon which the workpieces rest.

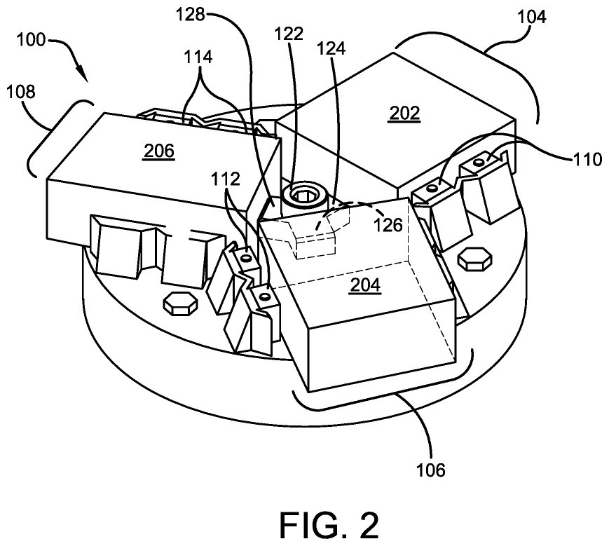

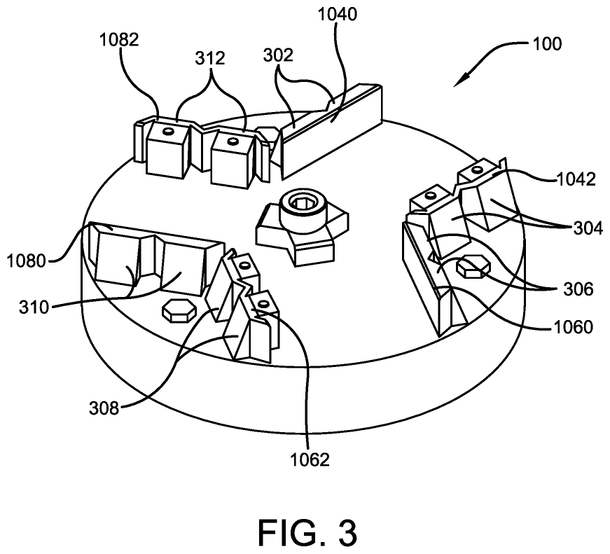

The machine 100 has three sets of dual jaws 104, 106, 108 wherein each jaw set is individually configured to hold a separate workpiece as best shown in FIG. 2. The first jaw set 104 includes a stationary jaw 1040 and a receptacle or movable jaw 1042 wherein the stationary jaw 1040 is stationary and fixed and the receptacle jaw 1042 includes a pair of tapered metal wedges 110. A workpiece is placed or gripped between the stationary jaw 1040 and the receptacle jaw 1042 and is secured by tightening the wedges 110 using a setscrew as best shown in FIG. 3. Similarly, the second jaw set 106 includes a stationary jaw 1060 and a receptacle or movable jaw 1062 wherein the stationary jaw 1060 is stationary and fixed, and the receptacle jaw 1062 includes a pair of tapered metal wedges 112. A second workpiece is placed or gripped between the stationary jaw 1060 and the receptacle jaw 1062 and is secured by tightening the wedges 112 using the jaw setscrew. A third jaw set 108 includes a stationary jaw 1080 and a receptacle or movable jaw 1082 wherein the stationary jaw 1080 is stationary and fixed and the receptacle jaw 1082 includes a pair of tapered metal wedges 114. A third workpiece is placed or gripped between the stationary jaw 1080 and the receptacle jaw 1082 and is secured by tightening the wedges 114 using the jaw setscrew.

As shown, the dual jaw sets 104, 106, 108 are laid out in a circular pattern concentric with the center 122 of the fixture body. The first jaw set 104 includes a center line 116 extending from the periphery of the base 102 to the center 122, the second jaw set 106 includes a center line 118 extending from the periphery of the base 102 to the center 122, the third jaw set 108 includes a center line 120 extending from the periphery of the base 102 to the center 122 and the jaw sets 104, 106, 108 are equally divided by one hundred and twenty degrees between their respective center lines 116, 118, 120.

At the center 122 of the machining fixture 100, three stationary protrusion or locators, or locator stops, extend vertically wherein each stationary protrusion or locator functions like a blockade (i.e. locator stop) to a workpiece positioned in a corresponding jaw set. As shown, a first stationary protrusion or locator 124 is positioned at the center 122 and along the center line 116 of the first jaw set 104. The first stationary protrusion or locator 124 functions to block the workpiece positioned between the stationary jaw 1040 and the receptacle jaw 1042 as shown in FIG. 2 for a smooth machining process on the workpiece. Similarly, a second stationary protrusion or locator 126 is positioned at the center 122 and along the center line 118 of the second jaw set 106. The second stationary protrusion or locator 126 functions to block the second workpiece positioned between the stationary jaw 1060 and the receptacle jaw 1062 as shown in FIG. 2 for a smooth machining process on the workpiece. A third stationary protrusion or locator 128 is positioned at the center 122 and along the center line 120 of the third jaw set 108. The third stationary protrusion or locator 128 functions to block the third workpiece positioned between the stationary jaw 1080 and the receptacle jaw 1082. The center 122 includes a central hole 130 that is used for fixing the fixture 100 on a surface using a mechanical screw 132 using a torque wrench (not shown). The fixture 100 includes a plurality of through holes 134 for attaching the fixture 100 to any surface such as a bench or table. Each through hole 134 is configured to receive a screw 136 for attaching the fixture 100 in a secure manner.

FIG. 2 illustrates a perspective view showing three separate workpieces fixed in three jaw sets of the triple vice machining fixture 100 of the present invention in accordance with the disclosed architecture. As shown, a first workpiece 202 is installed between the stationary jaw 1040 and the receptacle jaw 1042 of the first set of jaws 104. Further, the first workpiece 202 is blocked by the first protrusion or locator 124 such that lateral movement of the first workpiece 202 towards the center of the fixture 100 is eliminated during the machining process. The tapered wedges 110 are tightened to securely place the first workpiece 202 in the first set of jaws 104.

A second workpiece 204 is installed between the stationary jaw 1060 and the receptacle jaw 1062 of the second set of jaws 106. Further, the second workpiece 204 is blocked by the second protrusion or locator 126, such that lateral movement of the second workpiece 204 towards the center of the fixture 100 is eliminated during the machining process. The tapered wedges 112 are tightened to securely place the second workpiece 204 in the second set of jaws 106.

A third workpiece 206 is installed between the stationary jaw 1080 and the receptacle jaw 1082 of the third set of jaws 108. Further, the third workpiece 206 is blocked by a third protrusion or locator 128, such that lateral movement of the third workpiece 206 towards the center of the fixture 100 is eliminated during the machining process. The tapered wedges 112 are tightened to securely place the third workpiece 206 in the third set of jaws 108.

The fixture 100 is therefore configured to fix three separate workpieces 202, 204, 206 simultaneously for an operator to work with more efficiency by reducing time and frequency to prepare the fixture 100 for fixing new workpieces.

FIG. 3 illustrates the perspective view of vice machining fixture of FIG. 1 showing numeral references to the triangular wedges in accordance with the disclosed architecture. Each stationary jaw and receptacle jaw has triangular wedges on their exterior surfaces for providing additional stability to a workpiece placed between a set of the stationary jaw and receptacle jaw. As illustrated, the stationary jaw 1040 has triangular wedges 302, and the receptacle jaw 1042 has triangular wedges 304. The triangular wedges are integrally molded to the jaws and do not allow a workpiece to move easily.

The stationary jaw 1060 has triangular wedges 306, and the receptacle jaw 1062 has triangular wedges 308. The triangular wedges are integrally molded to the jaws and do not allow a workpiece to move easily. Similarly, the stationary jaw 1080 has triangular wedges 310, and the receptacle jaw 1082 has triangular wedges 312.

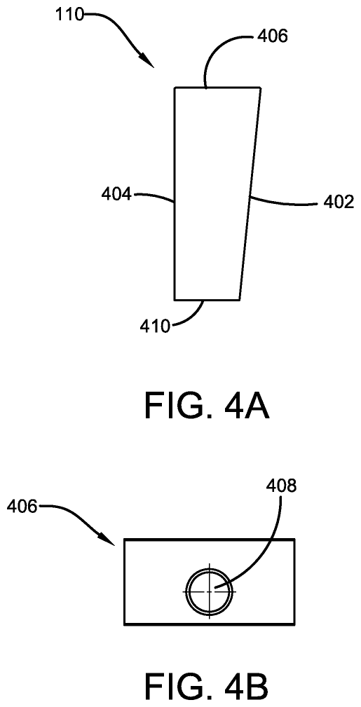

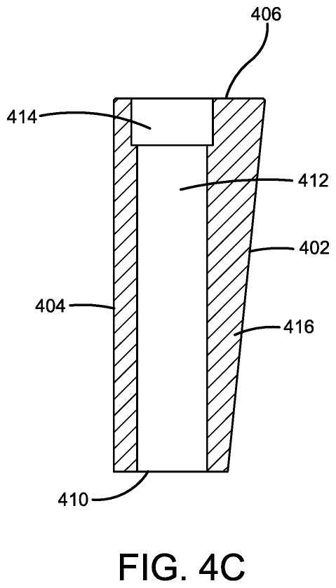

FIG. 4A illustrates a side view of a tapered metal wedge used in the vice machining fixture of the present invention in accordance with the disclosed architecture. The tapered metal wedge 110 is exemplary shown in the present embodiment and all the tapered wedges have similar dimensions and configuration. More specifically, the wedge 110 includes a slanting or tapered front surface 402, a flat vertical surface 404, a top surface 406 includes a hole 408 as shown in FIG. 4B, and a bottom surface 410 positioned on the top surface of the base 102. The flat vertical surface 404 is configured to attach to the receptacle jaw and the tapered edge 402 supports a workpiece placed or gripped between the receptacle jaw and the stationary jaw. The tapered front surface 402 includes a slant or angle from about 92 degrees to about 100 degrees with the bottom surface 410.

The top surface 406 includes a width from about 0.5 cm to about 1.1 cm and a length from about 1.2 cm to about 2.0 cm. The bottom surface 410 includes a width from about 0.3 cm to about 0.9 cm. Further, the flat vertical surface 404 includes a height from about 1.6 cm to about 2.4 cm.

FIG. 4B illustrates a top view of the tapered metal wedge 110 used in the vice machining fixture of the present invention in accordance with the disclosed architecture. As illustrated, a center of hole 408 can be positioned at 0.5 cm from one longer edge and 0.31 cm from the other opposing longer edge. Further, the center of the hole 408 can be positioned at a midpoint of the longer edge of the top surface 406.

FIG. 4C illustrates a side sectional view of the tapered metal wedge 110 showing the stationary and hollow portion in accordance with the disclosed architecture. Each metal wedge of the fixture of the present invention includes a hole (as illustrated in FIG. 4B) for receiving a screw 414 that can be tightened by a setscrew. The screw 414 is inserted into the hollow portion 412, which is surrounded by the stationary portion 416. The screw 414 can be the screw 136 described in FIG. 1.

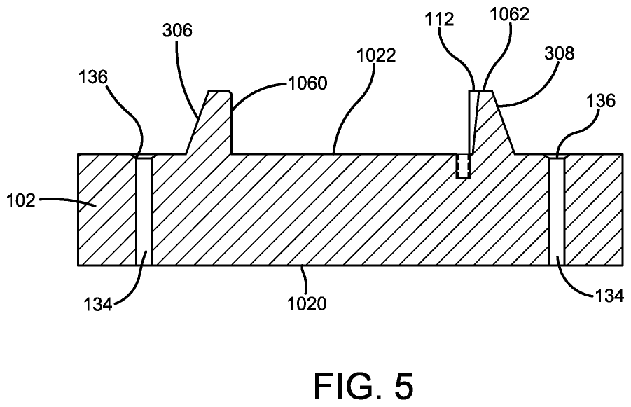

FIG. 5 illustrates a sectional view taken along line A-A of the triple vice machining fixture 100 of the present invention, in accordance with the disclosed architecture. As shown, the through holes 134 pass through the base 102 from the top surface 1022 to the bottom surface 1020. The screws 136 are used for mounting the vice fixture 100 on a surface. The stationary jaw 1060 includes the associated triangular wedge 306 and the receptacle jaw 1062 includes the triangular wedge 308. Further, the receptacle jaw 1062 includes the tapered wedge 112 that can be secured as described in FIG. 4C. The triangular wedge 306 forms an angle from about 100 degrees to about 120 degrees towards the respective jaw from the top surface 1022.

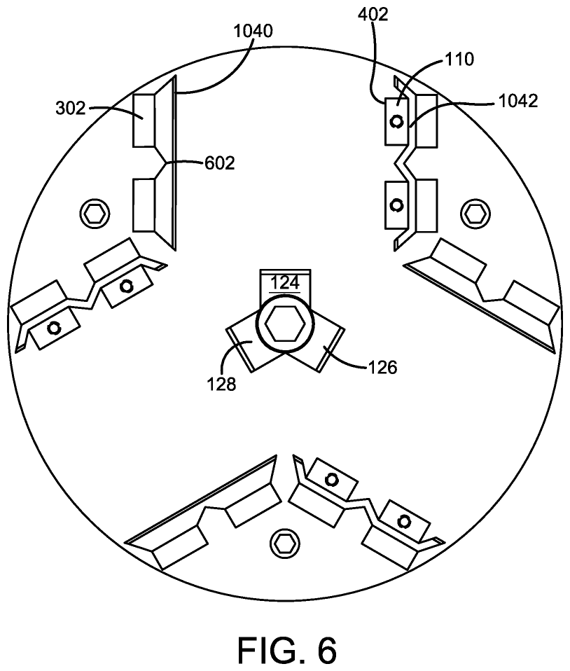

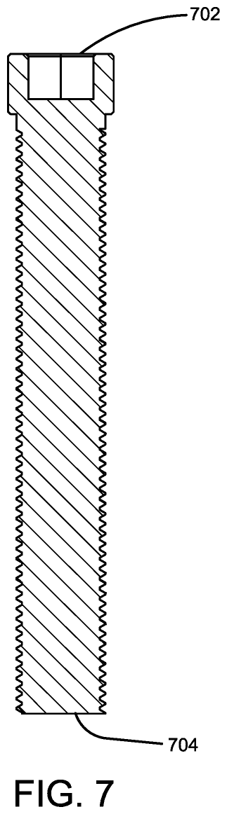

FIG. 6 illustrates a top perspective view showing illustrative and exemplary dimensions of various components of the triple vice machining fixture of the present invention in accordance with the disclosed architecture. Each of the protrusions 124, 126, 128 positioned at the center of the fixture 100 includes a width of 1.7 cm and a length of 1.3 cm. The distance between each stationary jaw and the tapered wedge associated with corresponding receptacle jaw is 7.5 cm. As shown, in one exemplary arrangement, the distance between the stationary jaw 1040 and the flat surface 402 of the tapered wedge 110 associated with corresponding receptacle jaw 1042 is 7.5 cm. The width of each triangular wedge is 1.8 cm and a distance between two consecutive triangular wedges is 1.1 cm. As shown, in one exemplary arrangement, a width of triangular wedge 302 is 1.8 cm and the length 602 is 1.1 cm. The thickness of each stationary jaw is 0.72 cm and the thickness of each triangular wedge is 0.73 cm.

FIG. 7 illustrates a perspective view of one potential embodiment of a fixture screw 132 in accordance with the disclosed architecture. As shown, the screw 132 is a threaded screw that includes a head 702 and a bottom end 704. The head 702 is 0.25 cm long and the screw 132 includes a total length of 2.75 cm. Also, there is a planar portion of 0.06 cm between the head 702 and the threaded portion of the screw.

The vice machining fixture of various embodiments can vary in diameter and length. The diameter of the fixture may vary to attach to a variety of surfaces. The fixture enables machinists, hobbyists, and others to maintain versatility in order to work on multiple items, pieces, or projects simultaneously. The fixture reduces the time required to clamp, secure, and machine workpieces without sacrificing quality.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vice machining fixture”, “triple vice machining fixture”, “multifunctional vice machining fixture”, and “fixture” are interchangeable and refer to the triple vice machining fixture 100 of the present invention.

Notwithstanding the forgoing, the triple vice machining fixture 100 of the present invention can be of any suitable size and configuration as is known in the art without affecting the overall concept of the invention, provided that it accomplishes the above-stated objectives. One of ordinary skill in the art will appreciate that the triple vice machining fixture 100 as shown in the FIGS. are for illustrative purposes only, and that many other sizes and shapes of the triple vice machining fixture 100 are well within the scope of the present disclosure. Although the dimensions of the triple vice machining fixture 100 are important design parameters for user convenience, the triple vice machining fixture 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments includes different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A triple vice machining fixture configured for securing up to three separate workpieces simultaneously, the triple vice machining fixture comprising:
a base for affixing to a planar surface thereunder, wherein said base includes a top surface upon which the workpieces are mounted;
a first jaw set having a first stationary jaw and a first receptacle jaw, wherein said first stationary jaw is fixed and said first receptacle jaw includes a first pair of tapered wedges, and further wherein a first workpiece is gripped between said first stationary jaw and said first receptacle jaw and is secured by tightening said first pair of tapered wedges using a first setscrew;
a second jaw set having a second stationary jaw and a second receptacle jaw, wherein said second stationary jaw is fixed and said second receptacle jaw includes a second pair of tapered wedges, and further wherein a second workpiece is gripped between said second stationary jaw and said second receptacle jaw and is secured by tightening said second pair of tapered wedges using a second setscrew;
a third jaw set having a third stationary jaw and a third receptacle jaw, wherein said third stationary jaw is fixed and said third receptacle jaw includes a third pair of tapered wedges, and further wherein a third workpiece is gripped between said third stationary jaw and said third receptacle jaw and is secured by tightening said third pair of tapered wedges using a third setscrew; and
further wherein said first jaw set, said second jaw set, and said third jaw set are arranged in a circular pattern concentric with a center of said base.

2. The triple vice machining fixture of claim 1, wherein said base is circular.

3. The triple vice machining fixture of claim 1, wherein said first jaw set includes a first center line extending from a periphery of said base to said center, the second jaw set includes a second center line extending from said periphery of said base to said center, said third jaw set includes a third center line extending from said periphery of said base to said center, further wherein said first jaw set, said second jaw set, and said third jaw set are equally spaced by 120 degrees between their respective said center lines.

4. The triple vice machining fixture of claim 3, further comprising a first locator positioned at said center and along said first center line of said first jaw set for positioning said first workpiece.

5. The triple vice machining fixture of claim 4, further comprising a second locator positioned at said center and along said second center line of said second jaw set for positioning said second workpiece.

6. The triple vice machining fixture of claim 5 further comprising a third locator positioned at said center and along said third center line of said third jaw set for positioning said third workpiece.

7. The triple vice machining fixture of claim 6, wherein said center includes a central hole and a mechanical fastener therethrough for fixing said vice fixture to the planar surface.

8. The triple vice machining fixture of claim 7, wherein said vice fixture includes a plurality of through holes and mechanical fasteners therethrough for fixing said vice fixture to the planar surface.

9. The triple vice machining fixture of claim 1, wherein said first pair of tapered wedges, said second pair of tapered wedges, and said third pair of tapered wedges are triangular.

10. The triple vice machining fixture of claim 9, wherein said first pair of tapered wedges, said second pair of tapered wedges, and said third pair of tapered wedges include the same dimensions.

11. A triple vice machining fixture configured for securing up to three separate workpieces simultaneously, the triple vice machining fixture comprising:
a base for affixing to a planar surface thereunder, wherein said base includes a top surface upon which the workpieces are mounted;
a first jaw set having a first stationary jaw and a first receptacle jaw, wherein said first stationary jaw is fixed and said first receptacle jaw includes a first pair of tapered wedges, and further wherein a first workpiece is gripped between said first stationary jaw and said first receptacle jaw and is secured by tightening said first pair of tapered wedges using a first setscrew;
a second jaw set having a second stationary jaw and a second receptacle jaw, wherein said second stationary jaw is fixed and said second receptacle jaw includes a second pair of tapered wedges, and further wherein a second workpiece is gripped between said second stationary jaw and said second receptacle jaw and is secured by tightening said second pair of tapered wedges using a second setscrew;
a third jaw set having a third stationary jaw and a third receptacle jaw, wherein said third stationary jaw is fixed and said third receptacle jaw includes a third pair of tapered wedges, and further wherein a third workpiece is gripped between said third stationary jaw and said third receptacle jaw and is secured by tightening said third pair of tapered wedges using a third setscrew;
wherein said first jaw set, said second jaw set, and said third jaw set are arranged in a circular pattern concentric with a center of said base; and
further wherein said first pair of tapered wedges, said second pair of tapered wedges, and said third pair of tapered wedges are triangular.

12. The triple vice machining fixture of claim 11, wherein said first jaw set includes a first center line extending from a periphery of said base to said center, the second jaw set includes a second center line extending from said periphery of said base to said center, said third jaw set includes a third center line extending from said periphery of said base to said center, further wherein said first jaw set, said second jaw set, and said third jaw set are equally spaced by 120 degrees between their respective said center lines.

13. The triple vice machining fixture of claim 12 further comprising a first locator positioned at said center and along said first center line of said first jaw set for positioning said first workpiece, a second locator positioned at said center and along said second center line of said second jaw set for positioning said second workpiece, and a third locator positioned at said center and along said third center line of said third jaw set for positioning said third workpiece.

14. The triple vice machining fixture of claim 11, wherein said first pair of tapered wedges, said second pair of tapered wedges, and said third pair of tapered wedges include the same dimensions.

15. The triple vice machining fixture of claim 14, wherein each said tapered wedge includes a slanting front surface, a flat vertical surface, a top surface including a hole therethrough, and a bottom surface positioned on said top surface of said base.

16. The triple vice machining fixture of claim 15, wherein said flat vertical surface is configured to attach to said receptacle jaw and said slanting front surface supports a workpiece gripped between said receptacle jaw and said stationary jaw.

17. The triple vice machining fixture of claim 16, wherein said slanting front surface and said bottom surface form an angle from about 92 degrees to about 100 degrees therebetween.

18. A triple vice machining fixture configured for securing up to three separate workpieces simultaneously, the triple vice machining fixture comprising:
a base for affixing to a planar surface thereunder, wherein said base includes a top surface upon which the workpieces are mounted;
a first jaw set having a first stationary jaw and a first receptacle jaw, wherein said first stationary jaw is fixed and said first receptacle jaw includes a first pair of tapered wedges, and further wherein a first workpiece is gripped between said first stationary jaw and said first receptacle jaw and is secured by tightening said first pair of tapered wedges using a first setscrew;
a second jaw set having a second stationary jaw and a second receptacle jaw, wherein said second stationary jaw is fixed and said second receptacle jaw includes a second pair of tapered wedges, and further wherein a second workpiece is gripped between said second stationary jaw and said second receptacle jaw and is secured by tightening said second pair of tapered wedges using a second setscrew;
a third jaw set having a third stationary jaw and a third receptacle jaw, wherein said third stationary jaw is fixed and said third receptacle jaw includes a third pair of tapered wedges, and further wherein a third workpiece is gripped between said third stationary jaw and said third receptacle jaw and is secured by tightening said third pair of tapered wedges using a third setscrew;
wherein said first jaw set, said second jaw set, and said third jaw set are arranged in a circular pattern concentric with a center of said base; and
further wherein each said tapered wedge includes a slanting front surface, a flat vertical surface, a top surface including a hole therethrough, and a bottom surface positioned on said top surface of said base.

19. The triple vice machining fixture of claim 18, wherein said flat vertical surface is configured to attach to said receptacle jaw and said slanting front surface supports a workpiece gripped between said receptacle jaw and said stationary jaw.

20. The triple vice machining fixture of claim 19, wherein said slanting front surface and said bottom surface form an angle from about 92 degrees to about 100 degrees therebetween.
